(19) United States
(12) Patent Application Publication
(10) Pub. No.: US 2012/0044044 A1
(43) Pub. Date: Feb. 23, 2012

(54) ELECTRONIC DEVICE WITH REMOTE CONTROL AND REMOTE CONTROL METHOD THEREOF

(75) Inventors: KUAN-HONG HSIEH, Tu-Cheng (TW); HAN-CHE WANG, Tu-Cheng (TW); BO-CHING LIN, Tu-Cheng (TW); XIN ZHAO, Shenzhen City (CN); CHIH-SAN CHIANG, Tu-Cheng (TW); HUA-DONG CHENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/083,584

(22) Filed: Apr. 10, 2011

(30) Foreign Application Priority Data
Aug. 20, 2010 (CN) 201010258692.1

(51) Int. Cl. G05B 19/02

(52) U.S. Cl. 340/4.3

(57) ABSTRACT

An electronic device comprising an input unit and a remote control for generating control signals; an interface unit; and a processor unit configured to analyze operation type according to the control signals, and control the electronic device to flip page. A remote control method applied in an electronic device is also provided.

### BACKGROUND

1. Technical Field

The present disclosure relates to electronic devices and, particularly, to an electronic device with remote control and a remote control method thereof.

2. Description of the Related Art

Many electronic devices provide mechanical buttons for devices to input commands. However, repetitive operations may cause users to feel tired, and in addition, the mechanical buttons occupy space making miniaturization difficult.

### BRIEF DESCRIPTION OF THE DRAWINGS

The components of the drawings are not necessarily drawn to scale, the emphasis instead being placed upon clearly illustrating the principles of an electronic device with remote control and a remote control method. Moreover, in the drawings, like reference numerals designate corresponding parts throughout multiple views.

FIG. 1 is a schematic view of an electronic device with a remote control in accordance with an exemplary embodiment.

FIG. 2 is a block diagram of a hardware infrastructure of the electronic device of FIG. 1.

FIG. 3 is a flowchart of a remote control method applied in an electronic device in accordance with an exemplary embodiment.

### DETAILED DESCRIPTION

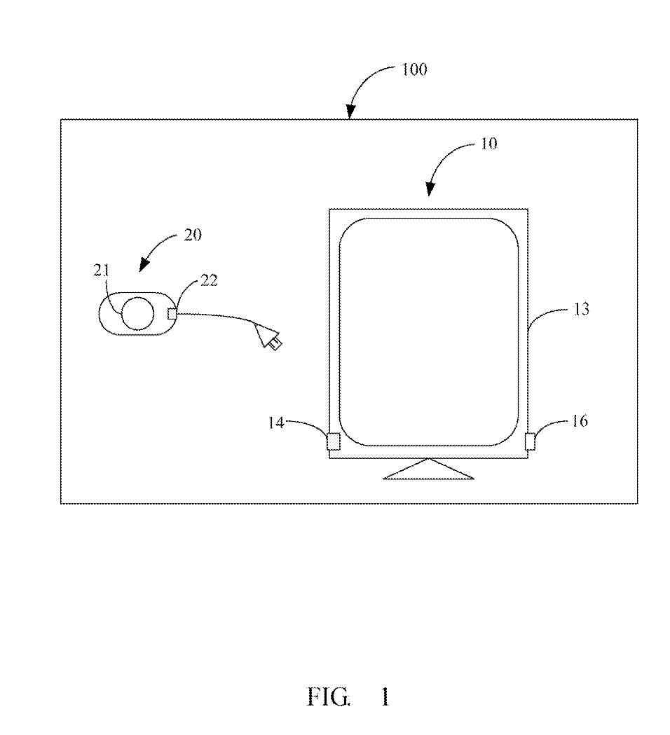

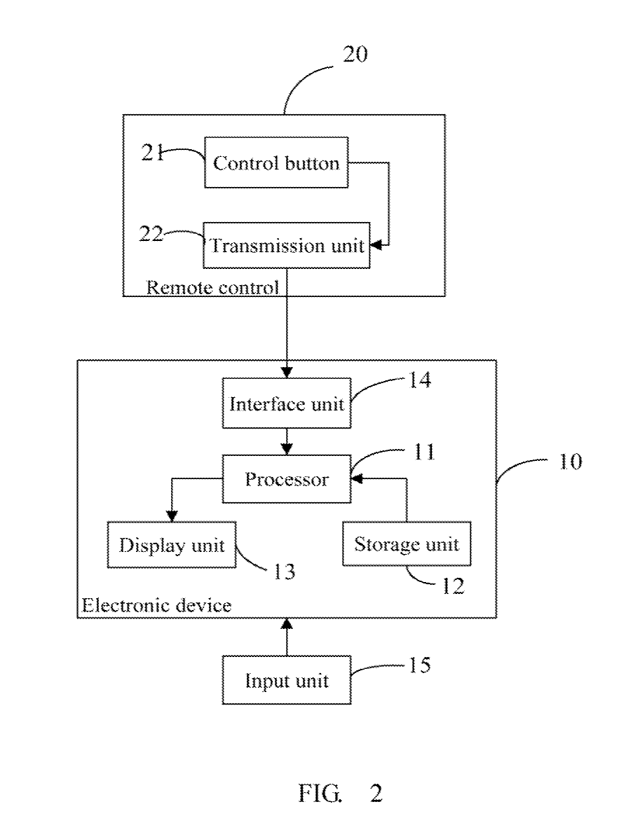

Referring to FIGS. 1 and 2, an electronic device 10 with a remote control 20. The electronic device 10 controls a displayed file to flip pages. The electronic device 10 includes a processor 11, a storage unit 12, a display unit 13, an interface unit 14 and an input unit 15. The storage unit 12 stores digital files. In the embodiment, the input unit 10 is a button 16 configured for generating control signals. Users can operate the button 16 or the remote control 20 to control the electronic device 10 to flip pages. In the embodiment, the remote control 20 is a control button, the control button generates control signals in response to pressing operations of users and transmits the control signals to the processor 11 via the interface unit 14. The processor 11 analyses the operation type of users according to the control signals from the remote control 20 or the button 16. The operation type is a first type, a second type, or a third type. If the operation type is the first type, the processor 11 controls the display unit 13 to flip a page forward; if the operation type is the second type, the processor 11 controls the display unit 13 to flip a page backward; if the operation type is the third type, the processor 11 controls the display unit 13 to return to the homepage.

In the embodiment, the remote control 20 is electrically connected to the electronic device 10 via a USB data line and transmits control signals to the electronic device 10 through the USB data line. The interface unit 14 is a Universal Serial Bus interface matching the USB data line.

In the embodiment, if a control signal exists beyond a first preset time period, but not beyond a second preset time period, such as 2 ms<t≦500 ms, the processor 11 determines that the operation type is the first type; if a control signal exists beyond the second preset time period, but not beyond a third preset time period, such as 500 ms<t≦2000 ms, the microprocessor 11 determines that the operation type is the second type; if the control signal exists beyond the third preset time period, such as t>2000 ms, the microprocessor 11 determines that the operation type is the third type.

In the embodiment, the button 16 of the input unit 15 is mounted on the sidewall of the electronic device 10 for users. The input unit 15 also includes a switch button and a mode button. The switch button is configured to power on or power off the electronic device 10. The mode button is configured to cause the electronic device to enter a reading mode. The electronic device displays a desired file, and the desired file is flipped via the button 16 or the remote control 20 depending on users' preferences.

In the embodiment, the remote control 20 includes a control button 21 or a touch panel, and a transmission unit 22. The control button 21 generates control signals according to operations of users. The transmission unit 22 is electrically connected with a data bus with a USB plug, the transmission unit 22 transmits the control signals to the processor 11 via the data bus. The length of the data bus is determined according to needs of users to facilitate the users to remotely control the electronic device 10 to flip page.

In another embodiment, the transmission unit 22 is a wireless transmission unit, such as an infrared transmission or an ultrasonic transmission. Correspondingly, the electronic device 10 includes a wireless receiving unit corresponding to the wireless transmission unit of the remote control 20. The processor 11 receives the control signals generated by the wireless transmission unit of the remote control 20 via the wireless receiving unit to control a displayed file to flip page.

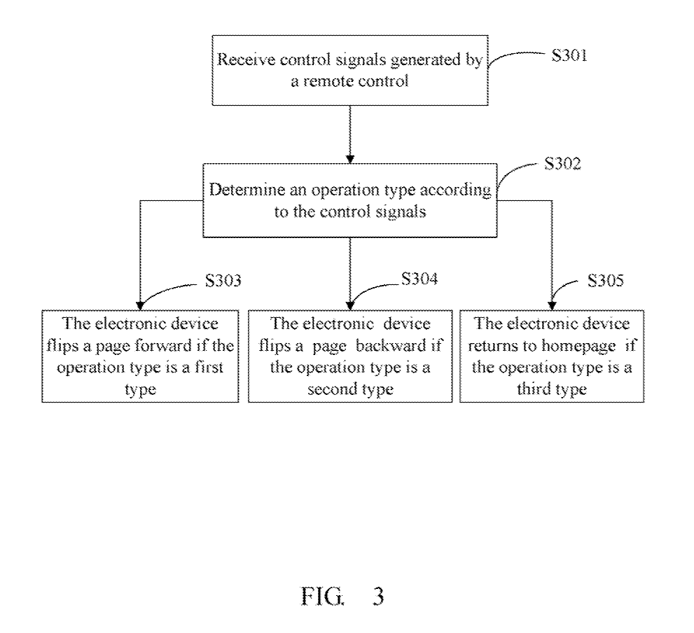

Referring to FIG. 3, shows a remote control method of an electronic device with a remote control in accordance with an exemplary embodiment.

In step S301, the processor 11 of the electronic device receives control signals generated by a remote control or an input unit of the electronic device.

In step S302, the processor 11 determines an operation type according to the control signals. The operation type is a first type, a second type, or a third type.

In step S303, the electronic device 200 flips a page forward if the operation type is the first type.

In step S304, the electronic device 200 flips a page backward if the operation type is the second type.

In step S305, the electronic device 200 returns to homepage of a currently read file if the operation type is the third type.

In the embodiment, if the control signal exists beyond a first preset time period, but not beyond a second preset time period, such as 2 ms<t≦500 ms, the processor 11 determines that the operation type is the first type; if the control signal exists beyond the second preset time period, but not beyond a third preset time period, such as 500 ms<t≦2000 ms, the processor 11 determines that the operation type is the second type; if the control signal exists beyond the third preset time period, such as t>2000 ms, the processor 11 determines that the operation type is the third type.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a remote control configured for generating control signals;
an interface unit configured for receiving the control signals from the remote control; and
a processor unit configured for analyzing an operation type according to the control signals, and control the electronic device to flip page, wherein if the operation type is a first type, the processor unit controls the electronic device to flip a page forward, if the operation type is a second type, the processor unit controls the electronic device to flip a page backward; if the operation type is a third type, the processor unit controls the electronic device to return to homepage of a currently read file.

2. The remote control as claimed in claim 1, wherein the interface unit receives the control signals via a USB data line.

3. The remote control as described in claim 1, wherein if the control signal exists beyond a first preset time period, but not beyond a second preset time period, the processor determines the operation type is the first type; if control signal exist beyond the second preset time period, but not beyond a third preset time period, the processor determines the operation type is the second type; if the control signal exists beyond the third preset time period, the processor determines the operation type is the third type.

4. The remote control as described in claim 1, wherein the interface unit is a wireless receiving unit comprising an infrared transmission or an ultrasonic transmission.

5. A remote control method applied to an electronic device, comprising:
providing a remote controller;
the electronic device receiving control signals generated by the remote control;
the electronic device determining an operation type according to the control signals; and
the electronic device flipping a page forward if the operation type is a first type, or flipping a page backward if the operation type is a second type, or returning to homepage of a currently read file if the operation type is a third type.

6. The remote control method as described in claim 5, wherein if the control signal exists beyond a first preset time period, but not beyond a second preset time period, determining the operation type is the first type; if control signal exist beyond the second preset time period, but not beyond a third preset time period, determining the operation type is the second type; if the control signal exists beyond the third preset time period, determining the operation type is the third type.

7. An electronic device comprising:
a remote control configured for generating control signals;
an interface unit configured for receiving the control signals from the remote control; and
a processor unit configured for analyzing an operation type according to the control signals, and control the electronic device to flip page.

8. The remote control as described in claim 7, wherein the operation type is a first type, a second type or a third type.

9. The remote control as described in claim 7, wherein if the operation type is the first type, the processor controls the electronic device to flip a page forward.

10. The remote control as described in claim 7, wherein if the operation type is the second type, the processor controls the electronic device to flip a page backward.

11. The remote control as described in claim 7, wherein if the operation type is the third type, the processor controls the electronic device to return to the homepage of a current reading file.

12. The remote control as described in claim 7, wherein the interface unit receives the control signals via a USB data line.

13. The remote control as described in claim 7, wherein if the control signal exists beyond a first preset time period, but not beyond a second preset time period, the processor determines the operation type is the first type; if control signal exists beyond the second preset time period, but not beyond a third preset time period, the processor determines the operation type is the second type; if the control signal exists beyond the third preset time period, the processor determines the operation type is the third type.

14. The remote control as described in claim 7, wherein the interface unit is a wireless receiving unit comprising an infrared transmission or an ultrasonic transmission.
